(19) United States
(12) Patent Application Publication
(10) Pub. No.: US 2006/0005162 A1
(43) Pub. Date: Jan. 5, 2006

(54) Computing system deployment planning method

(75) Inventors: Hui Ming Jason Tseng, Singapore (SG); Emarson Victoria, Singapore (SG); Hwee Hwa Pang, Singapore (SG); Tau Chen Cham, Singapore (SG)

Correspondence Address: CONLEY ROSE, P.C., P. O. BOX 3267, HOUSTON, TX, 77253-3267, US

(73) Assignee: Agency for Science, Technology And Research, Singapore (SG)

(21) Appl. No.: 10/514,748

(22) PCT Filed: Jun. 3, 2002
(86) PCT No.: PCT/SG02/00110

§ 371 Date: Jun. 2, 2005

(30) Foreign Application Priority Data
May 16, 2002 (SG) 0200095

(51) Int. Cl. G06F 9/44; G06F 15/173

(52) U.S. Cl. 717/107; 717/102; 709/223

(57) ABSTRACT

Management of the enterprise applications to maintain architectural integrity and performance of the entreprise applications is critical for providing avaliability of business services to users. When components of an application or computing system are moved between two systems, there is a need to reconfigure a previously configure system. Thus, the deployment requires complicated procedures that requires specialized training in the application being installed to ensure that system integrity is preserved at all times. A computing system deploymemt model introduces layers and clusters for segregating computing system, system and resources components based on their functionality and services provided thereby. Associations between components are registred in profiles to facilitate dependency tracking. The computer system deployment model allows for structured deployment of the computing system onto a host system. However, actual deployment of computing system components onto the host system is cost inefficient and time-consuming although components conflicts can be identified during the deployment stage. An embodiment of the invention facilitates deployment planning by utilising component profiles alone. A user mocks the actual deployment using a user interface to simulate different deployment configurations. The details of a successful mock deployment are captured for use in an actual deployment of the computing service and its components without compromise to the integrity of the host system. Cost consumption is also reduced by the alleviation of the need to use actual components during the deployment planning process.

### FIELD OF INVENTION

The present invention relates generally to a computing system deployment. In particular, the invention relates to a computing system deployment planning method for planning the deployment of computing system components.

### BACKGROUND

Conventional enterprise applications today possess multi-tier architectures. Unlike standalone applications in the past, these enterprise applications provide specialized solutions catering to different business needs within an organization or across geographically distant installations. The elaborate structure of these enterprise applications gives rise to vast quantity of heterogeneous enterprise back-end computing.

Management of the enterprise applications to maintain architectural integrity and performance of the enterprise applications is critical for providing availability of business services to users, for example customers.

The functions of the enterprise applications requiring management includes the deployment and configuration of service applications, system functionality diagnosis, maintenance of the integrity of component dependencies within an application and the monitoring and balancing of application component loading for improving application performance.

In the course of managing the enterprise applications, a situation requiring components of an application to be moved between two systems at different locations may arise. Alternatively, new resources may be made available to the system the enterprise applications reside within. In both these situations, there is a need to reconfigure a previously configured system. In most cases, the deployment of an application or its components requires complicated procedures that requires specialized training in the application being installed as system integrity has to be preserved at all times.

An enterprise application undergoes several configuration changes and a few versions of its associated components in the course of its life. Once an application is deployed within a system and becomes operational, it will undergo further component replacements, enhancements and expansion in scale.

Keeping the dependencies and the integrity of large scale systems becomes problematic as different applications are provided by possibly different vendors and the inter-connected systems, applications or its components needs to be performed by a administrator who is deploying the systems or applications. In such a situation, the dependencies and inter-connection requirements are provided to the administrator in the form of instructional manuals. Further knowledge of the requirements and limitations of each system, application or its components is dependant on the experience and tacit capability of the administrator.

It is desirable to have a common method of capturing or specifying all these information in a structured way, so that the dependency calculations could be automated.

A computing system deployment method addresses the foregoing issues by introducing layers and clusters for segregating computing system, system and resource components based on their functionality and services provided thereby. Associations between components are registered in profiles to facilitate dependency tracking. The computing system deployment model allows for structured deployment of the computing system onto a first host system. The profiles further facilitate migration of the computing system and its associated components onto a second host system without compromising system integrity.

However, the use of actual components during the deployment may be cost ineffective although the compatibility of a component or the viability of a components configuration is identified during deployment.

Hence, this clearly affirms a need for a computing system deployment planning method for planning the deployment of a computing system and the components thereof.

### SUMMARY

In accordance with a first aspect of the invention, there is disclosed a computing system deployment planning method comprising the steps of:

providing a plurality of components for modelling a computing system;

selecting a plurality of component icons, each component icon being representative of a component profile, each component profile being associated with a corresponding component;

invoking a dependency action between at least one pair of selected component icons, the dependency action being one of associating or disassociating the at least one pair of selected component icons;

analysing dependency action requirements between the at least one pair of selected component icons in response to invoking the dependency action therebetween, the dependency action requirements being the requirements for associating or disassociating the at least one pair of selected component icons;

providing a requirements compliance indication upon satisfying the dependency action requirements, the requirement compliance indication for indicating that the dependency action complies with the dependency action requirements; and

updating a deployment image with the at least one pair of selected component icons and the dependency actions therebetween in response to the requirements compliance indication, the deployment image being a record of the at least one pair of selected component icons and performed dependency action.

In accordance with a second aspect of the invention, there is disclosed a computing system deployment planning method comprising the steps of:

providing a plurality of components for modelling a computing system;

selecting a plurality of component icons being representative of a component profile, each component profile being associated with a corresponding component;

invoking a dependency action between at least one pair of selected component icons, the dependency action being one of associating or disassociating the at least one pair of selected component icons; and

analysing the compatibility between the at least one pair of associated component icons in accordance to the corresponding component profiles, the component profile containing:
at least one association requirement;
at least one association restriction; and
at least one contract specification, each contract specification indicating at least one parameter required by one component icon from another component icon for association thereto.

In accordance with a third aspect of the invention, there is disclosed a computing system deployment planning system comprising the means for:

providing a plurality of components for modelling a computing system;

selecting a plurality of component icons using a user interface, each component icon being representative of a component profile, each component profile being associated with a corresponding component, and the plurality of component icons being selected by a user;

invoking a dependency action between at least one pair of selected component icons, the dependency action being one of associating or disassociating the at least one pair of selected component icons;

analysing dependency action requirements between the at least one pair of selected component icons in response to invoking a dependency action therebetween, the dependency action requirements being the requirements for associating or disassociating the at least one pair of selected component icons;

providing a requirements compliance indication upon satisfying the dependency action requirements, the requirement compliance indication for indicating that the dependency action complies with the dependency action requirements; and

updating a deployment image with the selected component icons and the dependency actions therebetween in response to the requirements compliance indication, the deployment image being a record of the at least one pair of selected component icons and performed dependency action.

### BRIEF DESCRIPTION OF THE DRAWINGS

Embodiments of the invention are described hereinafter with reference to the following drawings, in which:

FIG. 1 shows a block diagram representing a computing system deployment model;

FIG. 2 shows a block diagram of a layer of the computing system deployment model of FIG. 1 with a plurality of components contained therein being grouped in clusters;

FIG. 3 shows a block diagram of a component profile of each component of FIG. 2;

FIG. 4 shows a block diagram of a deployment planning system in accordance to an embodiment of the invention for planning the computing system deployment model of FIG. 1;

FIG. 5 shows a block diagram of the deployment planning system of FIG. 4;

FIG. 6 shows a display representation of a graphical user interface (GUI) of the deployment planning system of FIG. 4; and

FIG. 7 shows a process flowchart of a computing system deployment planning method using the deployment planning system of FIG. 4.

### DETAILED DESCRIPTION

A computing system deployment planning method for addressing the foregoing problems is described hereinafter.

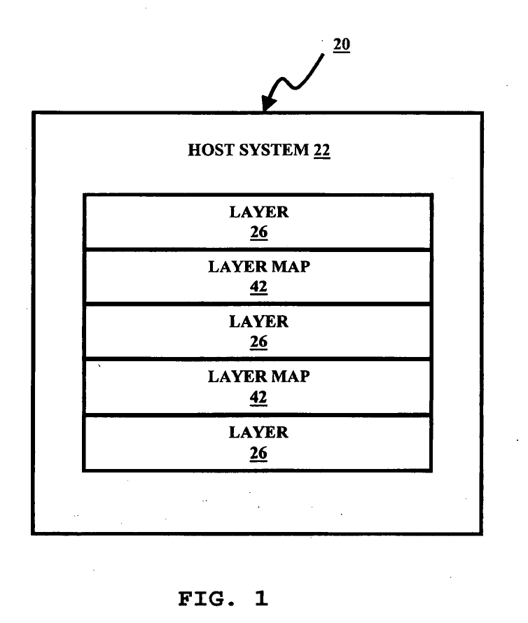

An embodiment of the invention, a computing system deployment planning method is described with reference to FIGS. 1 to 7. The computing system deployment planning method is based on a computing system deployment model 20. The computing system deployment model 20 is described with reference to FIG. 1, which shows a block diagram representing the computing system deployment model 20.

The computing system deployment planning method is for planning a deployment of a computing system (not shown) onto a computer-based host system 22. The computing system comprises a plurality of components 24 residing within the host system 22. These components 24 are generally classified as service components, system components and resource components (all not shown). These components 24 are organised into a plurality of layers 26 within the host system 22. The layers 26 typically include a service layer, system layer and resource layer, which respectively contain service, system and resource components.

System components are conventionally known as server components and are for providing computing system-based resources and services to other components 24 within the host system 22. These system components are, for example, DNS servers, FTP servers, system libraries, Windows registries and key repositories. Resource components represent one of a physical hardware that is associated with a computing node or a virtual device representing the physical hardware. Examples of hardware represented by resource components include network cards, hard disks, and memory modules.

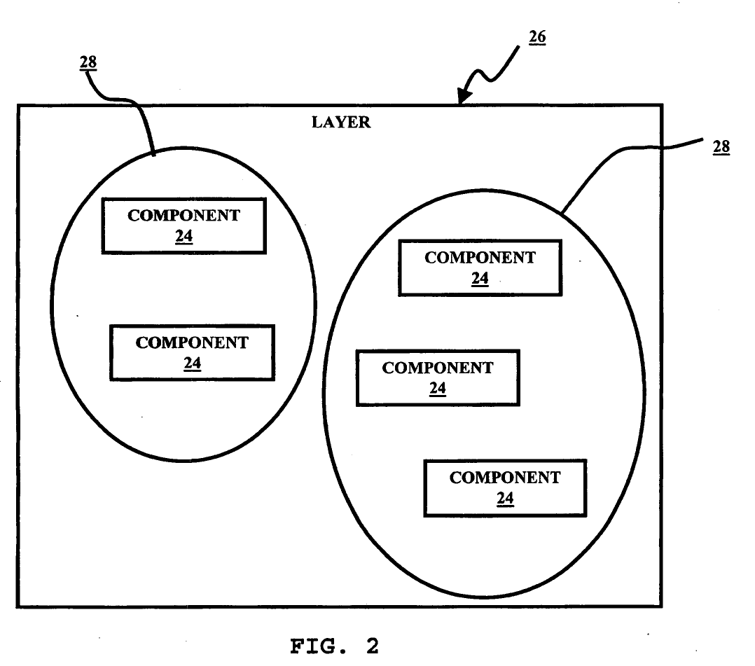

With reference to FIG. 2, the components 24 within each layer 26 are grouped into clusters 28 based on the function thereof. FIG. 2 shows a block diagram of one layer 26 of the computing system deployment model 20. Each cluster 28 within each layer 26 contains at least one component 24. In accordance to the computing system deployment model 20, the clusters 28 within the service layer, system layer and resource layer are referred to as the service clusters, system clusters and resource clusters respectively.

The service clusters relate to services provided by the computing system, with each service cluster containing at least one service components relating to a particular service. The resource cluster and the system cluster respectively contain resource components and system components having similar functions. The resource clusters include, for example, a firewall cluster, a network router cluster, a network switch cluster, a computing server cluster and a storage cluster. The system clusters include, for example, an operating system (OS) cluster, a database cluster and a virtual machine cluster.

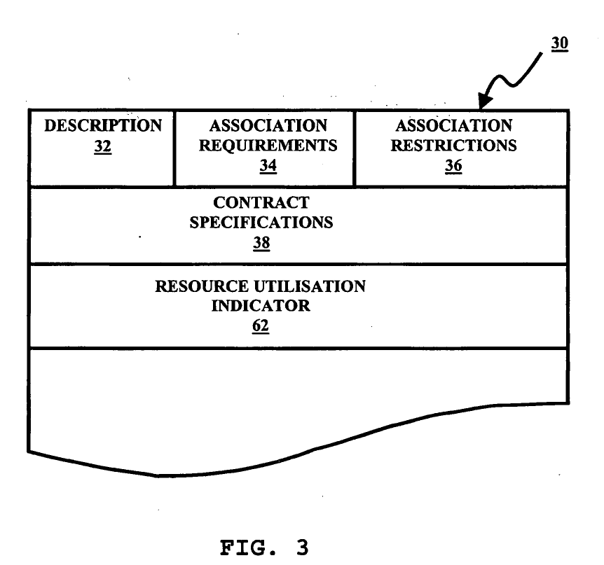

In accordance with the computing system deployment model 20, a component profile 30 is associated with each component 24. A block diagram of the component profile 30 is shown in FIG. 3. The component profile 30 comprises a description 32 of the associated component 24, at least one association requirement 34, at least one association restriction 36, and at least one contract specification 38, each contract specification 38 indicating at least one parameter required by another component 24 for association therewith.

Additionally, the component profile 30 may further includes run-time information (not shown) relating to how each component 24 is deployable and alterable parameters that affect the run-time behaviour of the component 24. The run-time information includes installation paths, network ports and addresses, locations of application-specific configuration files and logs, and the like component configuration details. The run-time information is one of application-specific, domain-specific and vendor-specific and ensures substantial accuracy in planning for the deployment of the computing system or the realisation of the computing system infrastructure.

Further in accordance with the computing system deployment model 20, each cluster 28 has an associated cluster profile 40 and each layer 26 has an associated layer map 42. The cluster profile 40 provide information on the specification of the component 24, and the layer map 42 of each layer 26 indicates the physical locality of the corresponding component 24 within the host system 22, and the association of another component 24 therewith.

When deploying a computing system onto the host system 22, the component profiles 30 of the components 24 enables the assessment of compatibilities of associations therebetween and the identification of association conflicts arising therefrom. However, the identification of conflict and compatibility issues at the stage of deploying the components 24 is both cost ineffective and time-consuming. The computing system deployment planning method alleviates the need to deploy the actual component 24 onto the host system 22 when planning for the deployment of a computing system.

Components 24 for a related service are typically purchased from a component vendor. The computing system deployment planning method allows for the deployment of services or a computing system with just the component profiles 30 of the required components 24. This allows a component vendor to supply component profiles 30 for deployment testing without the need to supply the components 24 until a purchase is required for the actual components 24.

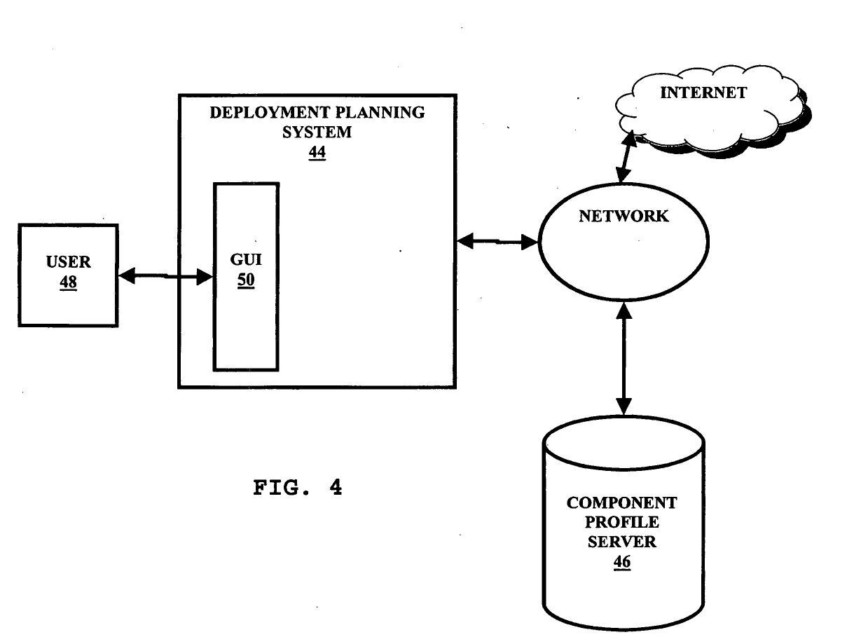

The computing system deployment planning method is implemented using a deployment planning system 44. With reference to FIG. 4, which shows a block diagram of the deployment planning system 44, the deployment planning system 44 resides on a computer-based system that is preferably networked for access to the Internet or a component profile server 46. A user 48 interacts with the deployment planning system 44 through a graphical user interface (GUI) 50.

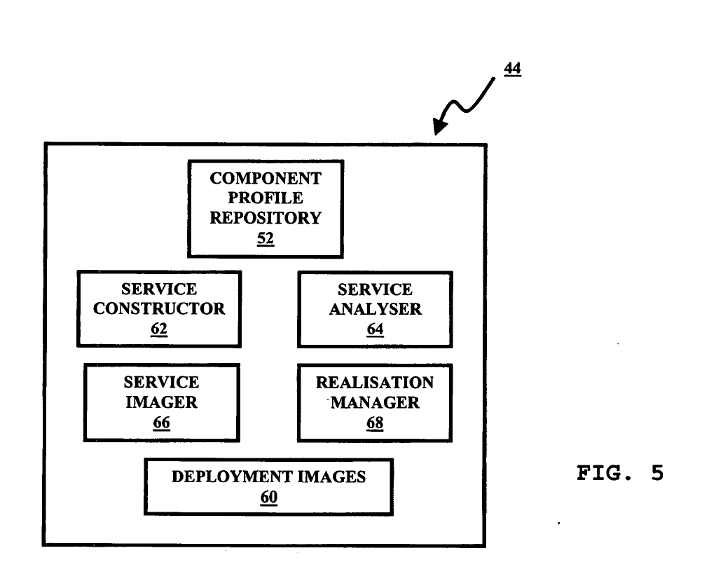

The deployment planning system 44 comprises a component profile repository 52 containing a plurality of component profiles 30 as shown in FIG. 5. The component profiles 30 contained in the component profile repository 52 are component profiles 30 for components 24 which are often used. Additionally, component profiles 30 for other components are downloadable from the Internet or the component profile server 46 maintained by the component vendor.

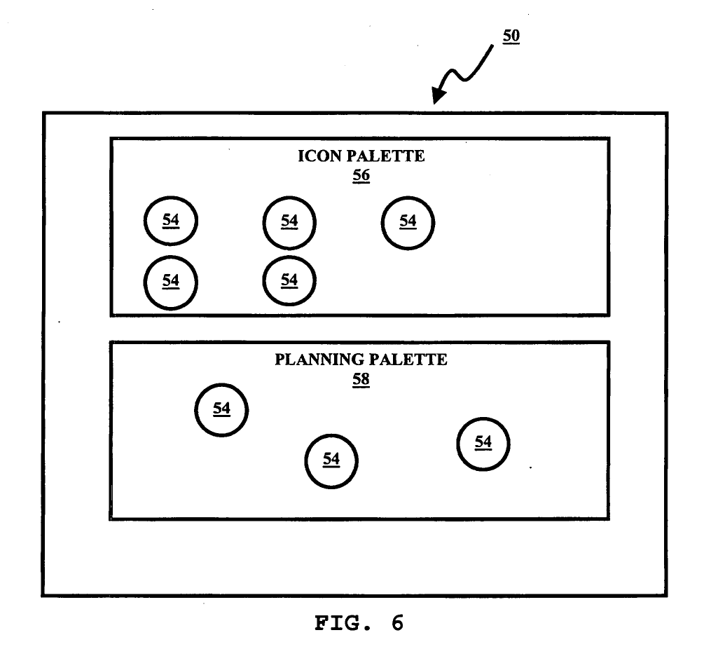

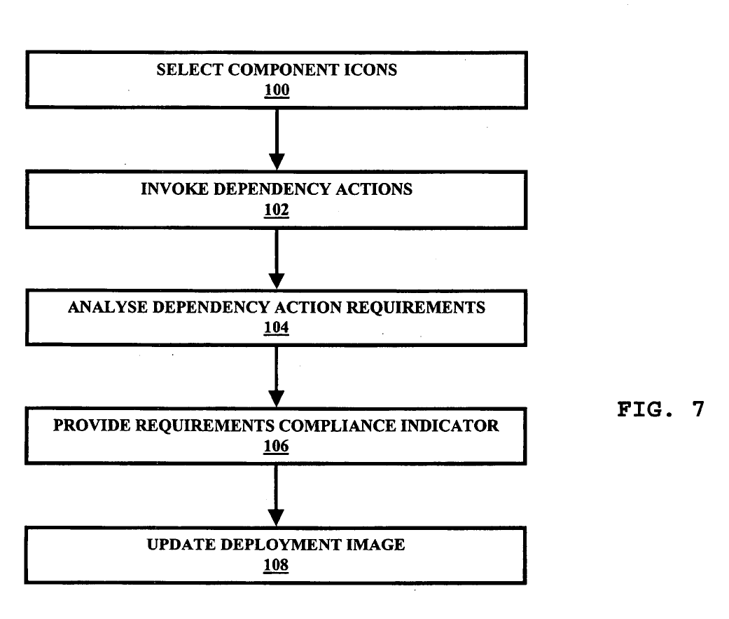

Each component profile 30 contained within the component profiles repository 52 is represented by a component icon 54. The component icons 54 are presented to the user 48 through the GUI 50 on an icon palette 56 thereof. FIG. 6 shows a display representation of the GUI 50, and FIG. 7 shows a process flowchart of the computing system deployment method using the deployment planning system 44. Using the GUI 50 as shown in FIG. 6, the user 48 selects a plurality of component icons 54, in a step 100 (of FIG. 7). The user 48 performs a drag-n-drop action to register the selection of the component icons 54 from the icon palette 56 onto a planning palette 58 of the GUI 50.

Once the required component icons 54 are selected and registered on the planning palette 58, the user 48 proceeds to perform dependency actions on the selected component icons 54, in a step 102 (of FIG. 7). The dependency actions include associating at least one pair of component icons 54 on the planning palette 58 by the user 48 performing drag-n-drop actions.

Alternatively, a deployment image 60 is obtained from the component profile server 46. The deployment image 60 provides templates or samples of previous computing system deployments. The deployment image 60 is a record of selected component icons 54 and the associations (also known as dependencies) therebetween. The deployment planning system 44 includes a service constructor 62 as shown in FIG. 5. When the deployment image 60 is required by the deployment planning system 44, the service constructor 62 reconstructs the selected component icons 54 and the associations contained therein onto the planning palette 58. The dependency actions further include disassociating at least one pair of already associated component icons 54, for example, from the deployment image 60 reconstruction by the service constructor 62.

The service constructor 62 emulates an environment of a previously deployed computing system by using the component icons 54 and the corresponding component profiles 30. The component profiles 30 and the information contained therein alleviate the need to physically deploy the components 24.

The service constructor 62 constructs the deployment environment onto the planning palette 58 of the GUI 50. The components 24 within a system and associations therebetween are conventionally recorded in a deployment repository (not shown) in accordance to the computing system deployment model 20. The deployment repository is represented by a deployment image 60 within the deployment planning system 44 by representing each component 24 with an associated component icon 54. The deployment image 60 coupled with the corresponding component 24 in the component profiles repository 52 facilitates the emulation of a close-to-reality deployment environment by the service constructor 62 within the deployment planning system 44 and is visually presented to the user 48 on the planning palette 58 of the GUI 50.

The deployment planning system 44 further includes a service analyser 64 as shown in FIG. 5. For every dependency action performed, in a step 102 (of FIG. 7), the service analyser 64 analyses dependency action requirements relating to the dependency action performed, in a step 104 (of FIG. 7). The analysis of dependency action requirements is performed on-the-fly by the service analyser 64 in response to actions by the user 48.

The run-time information of the component profile 30 is used for resource tracking by the service analyser 64. The run-time information includes installation paths, network ports and addresses, locations of application-specific configuration files and logs, and the like component configuration details. The service analyser 64 analyses the component profile 30 and determines if the required run-time information is available. If the required run-time information is unavailable, the user 48 is prompted to provide the unavailable run-time information via the GUI 50.

The run-time information is generally information based on a computing system's static configurations. As analysis by the service analyser 64 is independent of actual run-time behaviours, it does not make the run-time information less accurate if the run-time information is kept up-to-date. Thus, the run-time information does generally provide a reasonable representation of run-time behaviours.

The GUI 50 of the deployment planning system 44 includes a variation of views to enable the user 48 to better understand and track the selected component icons 54 on the planning palette 58 and the associations therebetween. The variation of views preferably includes an intuitive icon view with colour-coded line-connectors being visually representative of the dependencies between one component icon 54 and another associated component icon 54.

The variation of views preferably further includes a tree-view displaying the selected component icons 54 within a tree structure. The “branches” of the tree structure allows the user 48 to determine the association or dependency of one component icon 54 to another component icon 54. The variation of view preferably supports panning and zooming functions (not shown). The panning function permits the user 48 to navigate, using the GUI 50, and to select a specific component on the planning palette 58 for further analysis. The zooming function allows the user 48 to either select an overall view of a deployed computing system or to “zoom-in” onto a particular component 24 for in-depth analysis. Additional views, for example provided by a third-party vendor, can be added to the GUI's 50 variation of views to provide the user 48 with customised and/or improved visualisation tools.

When any two component icons 54 on the planning palette 58 of FIG. 6 are associated, the component profiles 30 associated therewith are analysed by the service analyser 64. The association requirements 34 of each component icon 54 are analysed to discover the availability of other required components icons 54 on the planning palette 58. The compliance between the two component icons 54 is also identified in accordance to the association restrictions 36. Next, the availability of parameters from one component icon 54 for another component icon 54 is identified in accordance to the contract specifications 38 of both component icons 54. The cluster profiles 40 of the clusters 28 containing the component icons 54 allocated within are assessed for any conflicts therebetween.

If the associations are successful, a requirement compliance indication is provided by the service analyser 64 and provided to the user 48 through the GUI 50, in a step 106.

If any conflicts arise from the associations, the user 48 is provided with an error message indicating the deficiency or problem arising from the intended associations between the component icons 54.

When any pair of component icons 54 on the planning palette 58 are disassociated, the component profiles 30 associated therewith are analysed by the service analyser 64. Any component icon 54 is unselected by performing a drag-n-drop action to transfer the component icon 54 from the planning palette 58 back onto the icon palette 56 using the GUI 50. With each disassociation and unselecting of component icons 54, the association requirements 34- of each component icon 54 are analysed to discover the dependency of other component icons 54 thereto. This is to prevent further conflicts from arising through the deployment actions of disassociation and unselecting. If the disassociations and unselecting of the component icons 54 are successful, a requirement compliance indication is provided to the user 48 through the GUI 50, in a step 106 (of FIG. 7). If any conflicts arise from the associations, the user 48 is provided with an error message indicating the problems arising from the intended disassociations between the component icons 54 and/or the unselecting of the component icons 54.

The deployment planning system 44 further includes a service imager 66 as shown in FIG. 5. Once the user 48 completes planning for the deployment of the required computing system or service, a new deployment image 60 is generated by the service imager 66 with the selected component icons 54 constructed on the planning palette 58 and the associations therebetween, module 108 (of FIG. 7). Alternatively, the user 48 has an option of updating an existing deployment image 60 using the service imager 66. The deployment image 60 is typically encrypted for security. The encryption controls user access to the deployment image 60 by different users 48. A user's 48 ability to either use the contents of the deployment image 60 and/or amend the contents therein is determined by different passwords used.

As shown in FIG. 5, the deployment planning system 44 further includes a realisation manager 68 and as shown in FIG. 3, the component profile 30 further contains a resource utilisation indicator 62. The resource utilisation indicator 62 enables the realisation manager 68 to perform a secondary action in response to the requirements compliance indication, in a step 106. The resource utilisation indicator 62 of each component icon 54 provides information on the computing system resource requirements of the corresponding component 24 when deployed on the host system 22. This enable the user to determine, with the deployment planning system 44, the current and future utilisation of computing system resources in accordance to the selected component icons 54 reflected on the planning palette 58 and the associations therebetween

The realisation manager 68 assists the user 48 in realising a deployment plan (not shown) created using the deployment planning system 44. The realisation manager 68 generates a procurement list (not shown) for the user 48 to execute the deployment plan systematically. The procurement list allows the user to make the relevant purchase of components 24. Additionally, the realisation manager 68 generates a guideline to determine the sequence and order of the components 24 for deployment.

In the foregoing manner, a computing system deployment planning method is described according to an embodiment of the invention for addressing the foregoing disadvantages of conventional practices for deploying computing systems. Although only one embodiment of the invention is disclosed, it will be apparent to one skilled in the art in view of this disclosure that numerous changes and/or modification can be made without departing from the scope and spirit of the invention.

1. A computing system deployment planning method comprising the steps of:
providing a plurality of components for modelling a computing system;
selecting a plurality of component icons, each component icon being representative of a component profile, each component profile being associated with a corresponding component;
invoking a dependency action between at least one pair of selected component icons, the dependency action being one of associating or disassociating the at least one pair of selected component icons;
analysing dependency action requirements between the at least one pair of selected component icons in response to invoking the dependency action therebetween, the dependency action requirements being the requirements for associating or disassociating the at least one pair of selected component icons;
providing a requirements compliance indication upon satisfying the dependency action requirements, the requirement compliance indication for indicating that the dependency action complies with the dependency action requirements; and
updating a deployment image with the at least one pair of selected component icons and the dependency actions therebetween in response to the requirements compliance indication, the deployment image being a record of the at least one pair of selected component icons and performed dependency action.

2. The computing system deployment method as in claim 1, wherein each component profile constitutes one of a plurality of component profiles provided within a component profiles repository, and each selected component icon being representative of one component profile available within the component profiles repository.

3. The computing system deployment planning method as in claim 1, wherein the step of obtaining a plurality of selected component icons comprises the steps of:
registering selection of a plurality of component icons; and
retrieving the component profile corresponding to each selected component icon.

4. The computing system deployment planning method as in claim 1, wherein the step of obtaining a plurality of selected component icons comprises the steps of:
providing a deployment image, the deployment image being a record of selected component icons and dependencies therebetween;
retrieving the component profile corresponding to each selected component icon; and
establishing dependencies between the selected component icons in accordance to the deployment image.

5. The computing system deployment planning method as in claim 1, wherein the component profile comprising:
a description of the component;
at least one association requirement;
at least one association restriction; and
at least one contract specification, each contract specification indicating at least one parameter required from another component for association thereto.

6. The computing system deployment planning method as in claim 5, wherein the step of obtaining a plurality of component icons comprises the steps of:
providing a plurality of layers on a host system, each layer having an associated layer map, and the plurality of layers comprising:
a service layer;
a system layer; and
a resource layer;
defining at least one cluster in each of the plurality of layers, each cluster having an associated cluster profile; and
allocating each selected component icon into one of the clusters defined in the plurality of layers.

7. The computing system deployment planning method as in claim 6, wherein the cluster profile of each cluster describes the general function of the component represented by the component icon allocated therein, and the layer map of each layer indicates the physical locality of the corresponding component of each component icon within a host system, and the association of another component icon with each component icon allocated therein.

8. The computing system deployment planning method as in claim 7, wherein the step of invoking a dependency action comprises the step of:
associating at least one pair of selected component icons.

9. The computing system deployment planning method as in claim 8, wherein the step of analysing dependency action requirements comprises the steps of:
analysing the component profiles of a source component icon and a target component icon, the source and target component icons constituting any pair of associated component icons;
discovering the availability of other selected component icons required by the association requirements of the source component;
identifying the compliance of the target component in accordance to the association restrictions of the source component; and
identifying the availability of parameters from the target component icon in accordance to the contract specifications of the source component icons.

10. The computing system deployment planning method as in claim 9, wherein the step of analysing dependency action requirements comprises the step of:
analysing the cluster profiles of the clusters the source and target component icons are allocated thereto and identifying conflicts therebetween.

11. The computing system deployment planning method as in claim 7, wherein the step of invoking a dependency action comprises the step of:
disassociating at least one pair of selected component icons.

12. The computing system deployment planning method as in claim 11, wherein the step of analysing dependency action requirements comprises the steps of:
analysing the component profiles of a source component icon and a target component icon, the source and target component icons constituting any pair of associated component icons in response to the step of disassociation; and
discovering the dependency of other selected component icons on the source component icon in accordance to the association requirements thereof.

13. The computing system deployment planning method as in claim 12, wherein the step of disassociating the source component icon and the target component icon comprises the step of:
unselecting the source component icon.

14. The computing system deployment planning method as in claim 7, wherein the step of updating the deployment image comprises the steps of:
updating the layer map of each layer; and
registering the selected component icons and the dependencies therebetween onto the deployment image.

15. The computing system deployment planning method as in claim 14, further comprising the step of:
initiating a secondary action in response to the step of providing a requirements compliance indication.

16. The computing system deployment planning method as in claim 15, wherein the step of initiating a secondary action comprises the step of:
quantifying current utilisation of computing system resource in accordance to the selected component icons and the dependencies therebetween.

17. The computing system deployment planning method as in claim 15, wherein the step of initiating a secondary action comprises the step of:
quantifying future utilisation of computing system resource in accordance to the selected component icons and the dependencies therebetween.

18. A computing system deployment planning method comprising the steps of:
providing a plurality of components for modelling a computing system;
selecting a plurality of component icons being representative of a component profile, each component profile being associated with a corresponding component;
invoking a dependency action between at least one pair of selected component icons, the dependency action being one of associating or disassociating the at least one pair of selected component icons; and
analysing the compatibility between the at least one pair of associated component icons in accordance to the corresponding component profiles, the component profile containing:
at least one association requirement;
at least one association restriction; and
at least one contract specification, each contract specification indicating at least one parameter required by one component icon from another component icon for association thereto.

19. A computing system deployment planning system comprising the means for:
providing a plurality of components for modelling a computing system;
selecting a plurality of component icons using a user interface, each component icon being representative of a component profile, each component profile being associated with a corresponding component, and the plurality of component icons being selected by a user;
invoking a dependency action between at least one pair of selected component icons, the dependency action being one of associating or disassociating the at least one pair of selected component icons;
analysing dependency action requirements between the at least one pair of selected component icons in response to invoking a dependency action therebetween, the dependency action requirements being the requirements for associating or disassociating the at least one pair of selected component icons;
providing a requirements compliance indication upon satisfying the dependency action requirements, the requirement compliance indication for indicating that the dependency action complies with the dependency action requirements; and
updating a deployment image with the selected component icons and the dependency actions therebetween in response to the requirements compliance indication, the deployment image being a record of the at least one pair of selected component icons and performed dependency action.

20. The computing system deployment system as in claim 19, wherein each component profile constitutes one of a plurality of component profiles provided within a component profiles repository, and each selected component icon being representative of one component profile available within the component profiles repository.

21. The computing system deployment planning system as in claim 19, wherein the means for obtaining a plurality of selected component icons comprises the means for:
registering selection of a plurality of component icons; and
retrieving the component profile corresponding to each selected component icon.

22. The computing system deployment planning system as in claim 21, wherein the means for registering selection of a plurality of component icons comprising:
an icon palette containing a plurality of component icons; and
a planning palette for receiving at least one component icon selected by the user from the icon palette.

23. The computing system deployment planning system as in claim 19, wherein the means for obtaining a plurality of selected component icons comprises the means for:
providing a deployment image, the deployment image being a record of selected component icons and dependencies therebetween;
allocating at least one selected component icon from an icon palette into a planning palette in accordance to the deployment image, the icon palette containing at least one component icon;
retrieving the component profile corresponding to each selected component icon; and
establishing dependencies between the selected component icons in accordance to the deployment image.

24. The computing system deployment planning system as in claim 19, wherein the component profile comprising:
a description of the component;
at least one association requirement;
at least one association restriction; and
at least one contract specification, each contract specification indicating at least one parameter required from another component for association thereto.

25. The computing system deployment planning system as in claim 24, wherein the means for obtaining a plurality of component icons comprises the means for:
providing a plurality of layers on a host system, each layer having an associated layer map, and the plurality of layers comprising:
a service layer;
a system layer; and
a resource layer;
defining at least one cluster in each of the plurality of layers, each cluster having an associated cluster profile; and
allocating each selected component icon into one of the clusters defined in the plurality of layers.

26. The computing system deployment planning system as in claim 25, wherein the cluster profile of each cluster describes the general function of the component represented by the component icon allocated therein, and the layer map of each layer indicates the physical locality of the corresponding component of each component icon within a host system, and the association of another component icon with each component icon allocated therein.

27. The computing system deployment planning system as in claim 26, further comprising:
an icon palette containing a plurality of component icons; and
a planning palette for receiving at least one component icon selected by the user from the icon palette.

28. The computing system deployment planning system as in claim 27, wherein the means for invoking a dependency action comprises the means for:
associating at least one pair of selected component icons received within the planning palette by the user using the user interface.

29. The computing system deployment planning system as in claim 28, wherein the means for analysing dependency action requirements comprises the means for:
analysing the component profiles of a source component icon and a target component icon, the source and target component icons constituting any pair of associated component icons;
discovering the availability of other selected component icons required by the association requirements of the source component;
identifying the compliance of the target component in accordance to the association restrictions of the source component; and
identifying the availability of parameters from the target component icon in accordance to the contract specifications of the source component icons.

30. The computing system deployment planning system as in claim 29, wherein the means for analysing dependency action requirements comprises the means for:
analysing the cluster profiles of the clusters the source and target component icons are allocated thereto and identifying conflicts therebetween.

31. The computing system deployment planning system as in claim 26, wherein the means for invoking a dependency action comprises the means for:
disassociating at least one pair of selected component icons received within the planning palette by the user using the user interface.

32. The computing system deployment planning system as in claim 31, wherein the means for analysing dependency action requirements comprises the means for:
analysing the component profiles of a source component icon and a target component icon, the source and target component icons constituting any pair of associated component icons in response to the means for disassociation; and
discovering the dependency of other selected component icons on the source component icon in accordance to the association requirements thereof.

33. The computing system deployment planning system as in claim 32, wherein the means for disassociating the source component icon and the target component icon comprises the means for:
unselecting the source component icon received within a planning palette by the user using the user interface.

34. The computing system deployment planning system as in claim 26, wherein the means for updating the deployment image comprises the means for:
updating the layer map of each layer; and
registering the selected component icons and the dependencies therebetween onto the deployment image.

35. The computing system deployment planning system as in claim 34, further comprising the means for:
initiating a secondary action in response to the means for providing a requirements compliance indication.

36. The computing system deployment planning system as in claim 35, wherein the means for initiating a secondary action comprises the means for:
quantifying current utilisation of computing system resource in accordance to the selected component icons and the dependencies therebetween.

37. The computing system deployment planning system as in claim 35, wherein the means for initiating a secondary action comprises the means for:
quantifying future utilisation of computing system resource in accordance to the selected component icons and the dependencies therebetween.
